(19) United States
(12) Patent Application Publication
(10) Pub. No.: US 2003/0069747 A1
(43) Pub. Date: Apr. 10, 2003

(54) Methods, systems, and articles of manufacture for providing fare trend information

(76) Inventors: Russell L. Strothmann, Broken Arrow, OK (US); Amela Abadzic-Ovcina, Plano, TX (US); Venkata Nagireddy, Galveston, TX (US); Dianne R. McQuarrie, Tulsa, OK (US)

Correspondence Address: Finnegan, Henderson, Farabow,, Garrett & Dunner, L.L.P., 1300 I Street, N.W., Washington, DC, 20005-3315, US

(21) Appl. No.: 10/267,581

(22) Filed: Oct. 10, 2002

Related U.S. Application Data
(60) Provisional application No. 60/327,790, filed on Oct. 10, 2001.

(51) Int. Cl. G06F 17/60

(52) U.S. Cl. 705/1

(57) ABSTRACT

Methods, systems, and articles of manufacture consistent with certain principles related to the present invention periodically collect historical fare information associated with fares previously offered by travel service providers for a predetermined amount of time. After each periodic collection, a set of lowest fares from among the collected historical fare information is extracted and stored in a separate database. The database may be continuously updated with new extracted lowest fare information upon each periodic collection of the historical fare information. The lowest fare information stored in the database may be made available to a requesting entity through, for example, the Internet. Accordingly, in accordance with certain principles related to the present invention, travel buyers and/or sellers may receive information reflecting the historical fares offered by travel service providers for a past predetermined amount of time.

### CROSS REFERENCE TO RELATED APPLICATION

This application is related to and claims the benefit of priority under 35 U.S.C. 119(e) to U.S. Provisional Patent Application No. 60/327,790, filed on Oct. 10, 2001, the disclosure of which is expressly incorporated herein by reference in its entirety.

### FIELD OF INVENTION

This invention relates to the travel industry, and more particularly, to methods, systems, and articles of manufacture for providing historical fare information associated with travel service providers.

### BACKGROUND OF THE INVENTION

The instability of airline fares is commonplace in the airline industry. Travelers and entities associated with the travel industry, such as travel agents, have grown to expect airline fares to change frequently and by large percentage amounts based on what is commonly known as “fare wars.” In conducting these fare wars, airlines offer fare sales several times every year in order to compete for potential consumers (e.g., travelers), but not necessarily at the same time or for the same duration. Also, the discounts offered by these fare sale varies widely from one sale to the next. Furthermore, there may be a fare sale on one market but not on another at any given point in time.

The travel seller and the travel buyer know only that fares vary, but there is no collecting mechanism that records these fares changes over a period of time that will inform the travel seller and buyer how the fares available today compare to fares that have been available in the past. Therefore, the travel seller or travel buyer do not know whether the fares they are paying today compares favorably or unfavorably to fares that have been available in the recent past and, given the consistent proclivity for airlines to offer fare sales, how the fares available today might compare to fares available at some point in the future.

### SUMMARY OF THE INVENTION

Accordingly, there is a present need for a system and a process that is capable of collecting past fare information associated with travel service providers and providing this information to a travel seller and/or buyer.

Methods, systems, and articles of manufacture consistent with certain principles related to the present invention may collect available fares associated with airlines in every city pair market, extract the lowest fares based on rule parameters, such as advanced purchase, and store those fares in a separate database. The available fares may be collected and stored periodically, such as every day, week, etc., for an extended period of time, such as one month, six months, twelve months, etc. The stored fares may then be extracted from the data base and displayed to a travel seller and buyer in textual or graphical format to provide comparative fare information over the extended period of time. In one configuration consistent with certain principles related to the present invention, the comparative fare information may be displayed through a browser executed by a processor operating in a client computer system. Methods, systems, and articles of manufacture consistent with certain principles related to the present invention may provide the travel seller and buyer with fare information that may influence a purchase decision based upon a value model associated with current available fares compared with past available fares and an analysis guideline of fares that may be available in the near future.

Additional aspects of the invention will be set forth in part in the description which follows, and in part will be obvious from the description, or may be learned by practice of methods, systems, and articles of manufacture consistent with features of the present invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

FIG. 1 illustrates an exemplary system environment, consistent with features and principles of the present invention;

FIG. 2 illustrates a flowchart of an exemplary process that may be performed by methods, systems, and articles of manufacture consistent with features and principles of the present invention; and

FIG. 3 illustrates a flowchart of another exemplary process that may be performed by methods, systems, and articles of manufacture consistent with features and principles of the present invention.

### DETAILED DESCRIPTION

Overview

Methods, systems, and articles of manufacture consistent with certain principles related to the present invention may provide a fare trend history analysis process to collect airline fares for every airline in every market on a daily basis. The lowest fare within certain variable rule parameters, such as advance purchases, are extracted from the collected daily fares and stored in a database. In one configuration consistent with certain principles related to the present invention, the fare trend history analysis process aggregates the lowest fares available within the rule parameters on a daily basis over a predefined period of time, such as 12 months. The aggregated fares may be made available to travel sellers and buyers in either text and/or graphical form through a network, such as the Internet.

Accordingly, methods, systems, and articles of manufacture consistent with certain principles related to the present invention allows travel sellers and buyers to have access to information associated with current available airline fares compared to similar fares that have been available in the past over a predetermined period of time. If the information provide to the travel sellers and buyers show that past fares were lower than the current fares, the sellers and buyers may decide that fares at some point in the future will be lower again, although that exact time may be unknown. Also, if current fares are at a relatively low compared to past fares with similar restrictions, the travel sellers and buyers may decide that the immediate purchase of airline tickets may be advantageous. In one configuration consistent with certain principles related to the present invention, a trend analysis may be performed that provides probability estimates of future air fares based on the collected historical fare information. The estimates may be provided to the travel sellers and buyers to allow them to make an informed decision on when to purchase airline tickets.

Computer Environment

Reference will now be made in detail to the exemplary aspects of the invention, examples of which are illustrated in the accompanying drawings. Wherever possible, the same reference numbers will be used throughout the drawings to refer to the same or like parts.

The above-noted features and other aspects and principles of the present invention may be implemented in various environments. Such environments and related applications may be specially constructed for performing the various processes and operations of the invention or they may include a general purpose computer or computing platform selectively activated or reconfigured by program code to provide the necessary functionality. The processes disclosed herein are not inherently related to any particular computer or other apparatus, and may be implemented by a suitable combination of hardware, software, and/or firmware. For example, various general purpose machines may be used with programs written in accordance with teachings of the invention, or it may be more convenient to construct a specialized apparatus or system to perform the required methods and techniques.

The present invention also relates to computer readable media that include program instructions or program code for performing various computer-implemented operations based on the methods and processes of the invention. The program instructions may be those specially designed and constructed for the purposes of the invention, or they may be of the kind well-known and available to those having skill in the computer software arts. Examples of program instructions include for example machine code, such as produced by a compiler, and files containing a high level code that can be executed by the computer using an interpreter.

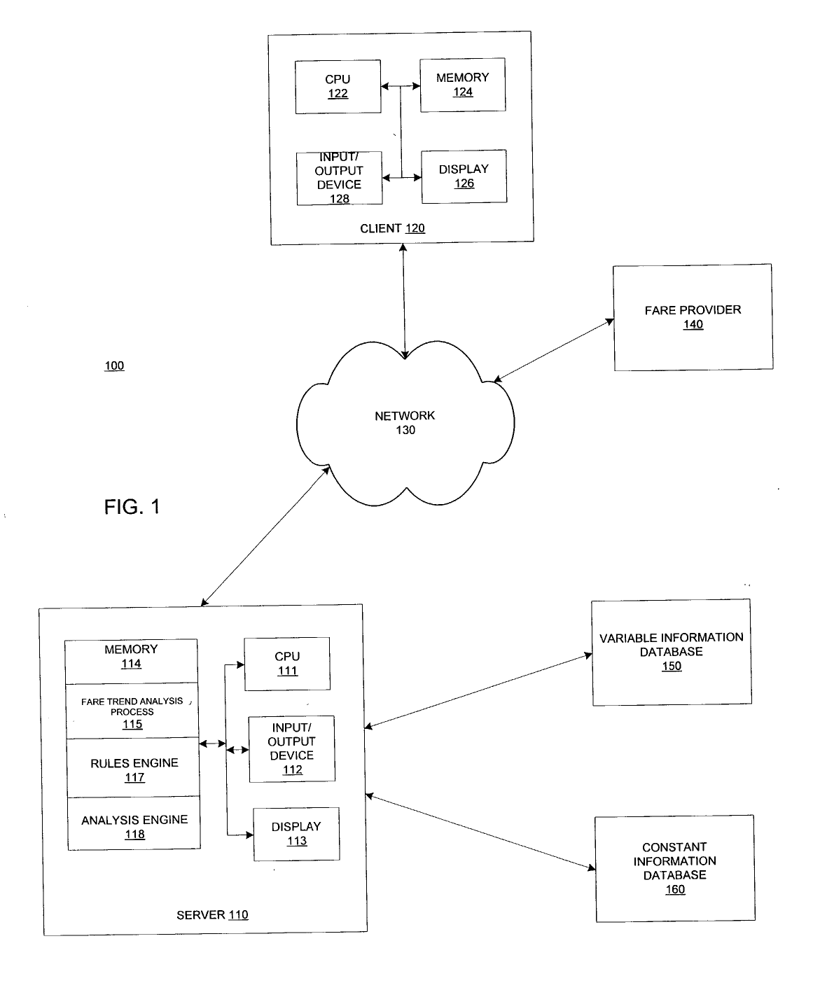

FIG. 1 is a diagram of a partially expanded view of an exemplary computer environment 100 in which certain features and aspects consistent with the present invention may be implemented. As shown, computer environment 100 may comprise server 110, client 120, network 130, fare provider 140, variable information database 150, and constant information database 160.

Server 110 may include a mainframe, server, personal computer, workstation, laptop, or any other similar computer system known in the art. Server 110 may comprise CPU 111, input/output 112, display 113, and memory 114. CPU 111 may be any type of processor (or processors) known in the art. CPU 111 may be configured to execute instructions and perform processes consistent with certain principles related to the present invention. Although FIG. 1 shows only one CPU 111 included in server 110, one skilled in the art would realize that a number of different architectures may be implemented by methods, systems, and articles of manufacture consistent with certain features related to the present invention. For example, CPU 111 may be replaced, or supplemented, by a plurality of processors that perform multi-tasking, multiprocessing operations.

Input/output device 112 may be any known computing component that allows server 110 to receive information from a user, such as a keyboard, mouse, pointing device, and any other similar component known in the art. Furthermore, input/output device 112 may also include computing components that allow server 110 to output data to a user via a display 113 and/or printing device (not shown). Furthermore, input/output device 112 may also include computing components that enable server 110 to output data to entities external to server 110. For example, input/output device 112 may include computing components that establishes connections with network 130, variable information database 150, constant information database 160, and any other entity that may be connected to server 110, either directly or indirectly. One skilled in the art would realize that input/output device 112 may include one or more components that perform dedicated functions, such as network connections, user interface operations, and memory access operations, without departing from the scope of the present invention.

Display 113 may be any known device that presents information to a user, such as a computer display terminal. Memory 114 may be may be any known type of storage device that stores data. Memory 114 may include, but is not limited to, magnetic, semiconductor, and/or optical type storage devices. Memory 114 may also be a storage device that allows CPU 111 quick access to data, such as a cache memory. In one configuration consistent with selected features related to the present invention, memory 114 may store data and/or program instructions to implement methods consistent with certain features related to the present invention.

Memory 114 may also include fare trend analysis process 115, rules engine 117, and analysis engine 118. In one configuration consistent with certain principles related to the present invention, fare trend analysis process 115 may be a process that, when executed by CPU 111, extracts and filters the lowest fares from variable information database 150, and stores the extracted fares in constant information database 160. Rules engine 117 may be a process that, when executed by CPU 111, provides rule parameters associated with the fares stored in a storage device (e.g., constant or variable information database 160, 150) to allow fare trend analysis process to extract and filter the fares stored in variable information database 150. Analysis engine 118 may be a process that, when executed by CPU 111, performs a trend analysis on the fares stored in constant information database 160 and provides estimated future fare trend information consistent with certain principles related to the present invention. One skilled in the art would realize that fare trend analysis 115, rules engine 117, and analysis engine 118 may be configured as a single process and may also be located in a memory remote from server 110 without departing from the scope of the present invention.

Client 120 may include a mainframe, client computer, personal computer, workstation, laptop, personal digital assistant, or any other similar computer system known in the art. Client 120 may be operated by one or more users that may represent a travel buyer, such as a passenger, and a travel seller, such as a travel agent or an agent associated with a travel service provider such as an airline employee. It should be noted that these examples are not intended to be limiting and one skilled in the art would realize that client 120 may be operated by a number of different types of users without departing from the scope of the invention.

Client 120 may comprise CPU 122, memory 124, display 126, and input/output device 128. CPU 122 may be configured to execute instructions and perform processes consistent with certain principles related to the present invention. Although FIG. 1 shows only one CPU 122 included with client 120, one skilled in the art would realize that a number of different architectures may be implemented by methods, systems, and articles of manufacture consistent with certain features related to the present invention. For example, CPU 122 may be replaced, or supplemented, by a plurality of processors that perform multi-tasking operations.

Memory 124 may be may be any known type of storage device that stores data. Memory 124 may include, but is not limited to, magnetic, semiconductor, and/or optical type storage devices. Memory 124 may also be a storage device that allows CPU 122 quick access to data, such as a cache memory. In one configuration consistent with selected features related to the present invention, memory 124 may store data and/or program instructions to implement methods consistent with certain features related to the present invention, such as a browser program that exchanges information with network 130 through input/output device 128. Display 126 may be any known device that presents information to a user, such as a computer display terminal. Input/output device 128 may be any known computing component that allows client 120 to receive information from a user, such as a keyboard, mouse, pointing device, and any other similar components known in the art. Furthermore, input/output device 128 may also include computing components that allow client 120 to output data to a user via a display 126 and/or printing device (not shown). Furthermore, input/output device 128 may also include computing components that enable client 120 to output data to entities external to client 120. For example, input/output device 128 may include computing components that establishes connections with network 130. One skilled in the art would realize that input/output device 128 may include one or more components that perform dedicated functions, such as network connections, user interface operations, and memory access operations, without departing from the scope of the present invention.

Network 130 may be any type of network known in the art. For example, network 130 may include a Local Area Network, Wide Area Network, combinations of switching networks, and the Internet. Furthermore, network 130 may process wireline and wireless communications to and from any entity attached thereto.

Fare provider 140 may be a entity that provides fare information associated with a travel service provider. The term travel service provider, as used herein, may reflect any type of entity that provides, and/or is associated with an entity that provides, services associated with the travel industry, such as an airline, hotel, car rental agency, train travel service provider, bus travel service provider, and any other type of provider associated with the travel industry. Furthermore, although FIG. 1 shows one fare provider 140, system 100 may include a plurality of fare providers 140 associated with the same or different travel service providers. In one configuration consistent with certain principles related to the present invention, fare provider 140 may represent a plurality of carriers of airline travel, such all carriers of airline travel in the United States.

Variable and constant information databases 150, 160 may each be any known type of storage device that stores data. Variable and constant information databases 150, 160 may include, but are not limited to, magnetic, semiconductor, and/or optical type storage devices. In one configuration consistent with certain principles related to the present invention, variable information database 150 may store fare information collected by server 110 from fare provider 140, while constant information database 160 may store fare information that has been extracted and filtered by fare trend analysis process 115. Further, databases 150 and 160 may be configured as relational databases that associate various type of information using known relational memory management techniques and operations.

It should be noted that the configuration of computing environment 100 is exemplary and is not intended to be limiting. One skilled in the art would appreciate that different components and architectures may be implemented without departing from the spirit and scope of the present invention.

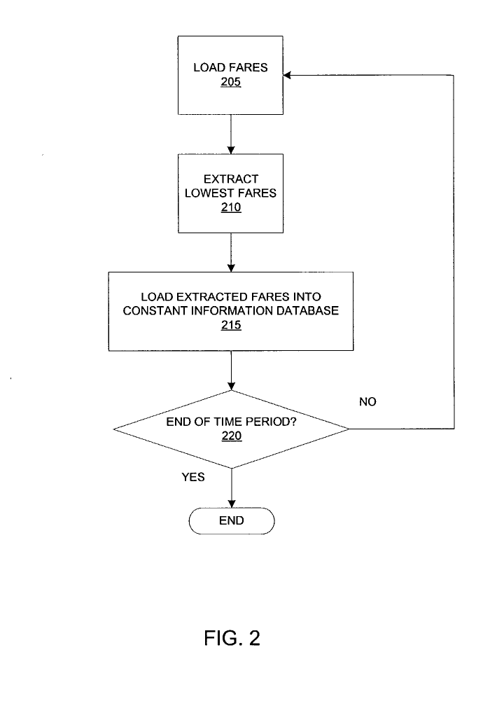

Methods, systems, and articles of manufacture consistent with certain principles related to the present invention may allow travel buyers and sellers to receive information reflecting current and past fares associated with the travel industry, such as airlines and hotels, to determine the future trends associated with these fares. FIG. 2 shows a flowchart reflecting an exemplary process that may be performed within computing environment 100. The process may begin by server 110 collecting some or all of the fare information associated with one or more (e.g., every) travel opportunities provided by one or more travel service providers, such as all flights offered by every airline in a particular market or markets. For example, server 110 may be configured to collect fare information for every available flight provided by every airline in the United States. The fare information may include pricing data associated with each travel service offered by an associated travel service provider and/or information associated with the type of travel service offered (e.g., available seats, types of available seats, amenities offered during travel, etc.). The configuration may be expanded to other markets, such as flights destined abroad, or may be restricted to flights associated with particular regions within the United States (e.g., east coast, interstate, and intrastate flights). Once the target market and travel service provider(s) are identified by server 110, CPU 111 may be configured to access the fare information provider by fare provider 140, via network 130, and download the fare information to variable information database 150 (Step 205).

Further, concurrently, prior to, or following the collection of fare information, server 110 may collect one or more rule parameters associated with the travel services provided by the travel service providers corresponding to fare provider 140. In one aspect of the invention, server 110 may collect the rule parameters from fare provider 140. Alternatively, server 110 may collected the rule parameters from a storage device local to server 110. In another aspect of the invention, concurrently, following or prior to, collecting the fare information, server 110 may generate one or more rule parameters associated with the collected fare information. For example, high level fare application data (e.g., rule parameters) may be extracted at the same time the fare information is collected from fare provider 140. Accordingly, as server 110 adds new fare information to variable information database 150, server 110 assures that there is a corresponding rule parameter, such as advance purchase, minimum stay, maximum stay, and/or travel dates associated with the travel service corresponding to the collected fare information.

Once the fare information has been stored in variable information database 150, CPU 111 may invoke fare trend analysis process 115 and rules engine 117 to extract the lowest fares from variable information database 150 and filter the fare information based on one or more rule parameters provided by rules engine 117 (Step 210). Rules engine 117 may locate and retrieve the one or more rule parameters maintained by server 110 for fare trend analysis processing. The one or more rule parameters accessed by rules engine 117 may be associated with selective criteria that may affect the fare amount for particular flights. For example, as indicated above, the one or more rule parameters may be associated with advance purchase criteria and minimum and/or maximum stay criteria. Because airlines, for example, may offer lower fares for flights that are booked in advance by a predetermined amount of time (e.g., 30 days), rules engine 117 may process one or more rule parameters that fare trend analysis process 115 follows to ensure the comparison among the fares is done under the same criteria. Rules engine 117 may be configured to provide the corresponding rule parameters to fare trend analysis process 115.

Once fare trend analysis process 115 receives designated rule parameters from rules engine 117, it may locate the lowest fares for every flight that meets the designated rule parameters. For example, fare trend analysis process 115 may locate the lowest fare information associated with every flight that may be booked 14 days in advance. The lowest fare information is extracted from the fare information stored in variable information database 150 and stored in constant information database 150 (Step 215). The extracted fare information may be stored in a designated file located in constant information database 160 associated with the date when the extraction process took place. Alternatively, the extracted fare information may be aggregated with previously stored extracted fair information in a common file or storage location(s) within constant information database 160. Further, the one or more rule parameters provided by rules engine 117 may also be stored in constant information database 160. Analysis engine 118 may be configured to store the rule parameters and filtered fare information in a relational database file that affiliates each rule parameter with corresponding filtered fare information.

In one configuration consistent with certain principles related to the present invention, once constant information database 160 stores the extracted fare information, variable information database 150 may be purged of the fare information it received from server 110, in preparation for the next downloading of new fare information that may be subsequently collected from fare provider 140. Alternatively, database 150 may maintain the fare information collected by fare trend analysis process 115. Further, because fare information may include changes from a travel service provider that are not relevant to a change in the price of a travel service (e.g., sales data, footnote changes, etc.), server 110 may merge the irrelevant changes into a single fare item to minimize database file size.

Once fare trend analysis process 115 has completed extracting the lowest fare information that meets the rule parameters designated by rules engine 117, and stored the extracted fare information in constant information database 160, server 110 may determine whether a predetermined time threshold has been reached (Step 220). This threshold may be associated with a historical time period that may be set by server 110, such as a predetermined date, or a period of time, such as 12 months, 2 years, etc., extending from the day server 110 first stored extracted fare information in constant information database 160. During the time period, the fare information is continuously updated in variable information database 150, extracted, filtered and stored in constant information database 160. Thus, when the time period or threshold is not reached (Step 220; NO), server 110 may be configured to repeat steps 205-220 until the threshold has been reached. In one configuration consistent with certain principles related to the present invention, server 110 may be configured to load new fare information from fare provider 140 once a day. One skilled in the art would realize that server 110 may perform this process more than once a day, or even weekly, monthly, every other day, etc., without departing from the scope of the present invention.

In the event that the end of the time period (threshold) has been reached (Step 220; YES), the process may end. In one configuration consistent with certain principles related to the present invention, instead of ending the process, server 110 may repeat the process shown in FIG. 2 for another designated time period (e.g., the next 6 months) and store extracted fare information in a separate file located in constant information database 160 designated for this new time period. Alternatively, server 110 may store new extracted fare information in the same file as the previously stored extracted fare information, thus continuously aggregating the extracted fare information into a common location for processing by server 110. One skilled in the art would appreciate that there are a number of different techniques that may be employed to store and file the extracted fare information without departing from the scope of the invention.

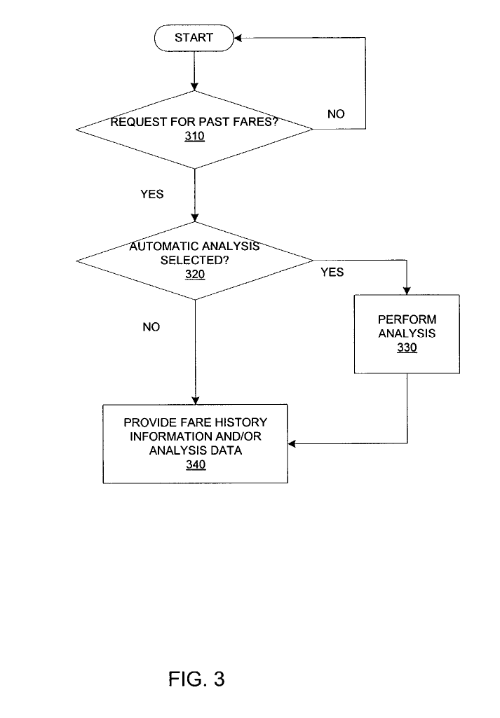

FIG. 3 shows a flowchart of an exemplary process that may be performed by methods, systems, and articles of manufacture consistent with certain principles related to the present invention in response to a request for historical (i.e., past) fares from client 120. At some point, a requesting source, such as a user (e.g., travel buyer or seller) operating client 120 may decide that they wish to obtain fare information previously offered by one or more travel service providers, such as airlines, during a previous period of time, such as the past 6 months. In one configuration consistent with certain principles related to the present invention, the user may access a web site provided by a web server that offers this information to requesting users through a network. For example, a user may operate a computer system (e.g., client 120) executing a browser application located in memory 124 to access the exemplary web site through network 130. Client 120 may receive content from the web site that includes one or more options for viewing fare information. For example, the user may be provided with an option of selecting certain types of flights associated with certain destination and/or source locations, certain markets, and/or an option of selecting aggregated fare information offered by one or more airlines over the predetermined time period. Furthermore, the user may be provided with an option of having server 110 perform an automatic trend analysis for the designated previous time period to provide an estimated future fare trend result. Once the user selects the appropriate option, client 120 may be configured to provide a request for past fares to server 110.

At Step 310, server 110 may determine whether a request for past fares has been received from client 120. If not, server 110 may wait until such a response is received (Step 310; NO). If, however, a request has been received from client 120 (Step 310; YES), server 110 may determine whether the request indicates that the user selected the automatic trend analysis option (Step 320). If the request does indicate that the automatic trend analysis option was selected, CPU 111 may be configured to invoke the analysis engine 118 to perform a trend analysis process on the extracted fare information stored in constant information database 160.

In one configuration consistent with certain principles related to present invention, analysis engine 118, when executed by CPU 111, may perform a process that provides a prediction of a value of future fares based on the past fare information stored in constant information database 160. The prediction may be associated with a future time range, such as the next 30 days, 2 months, etc., and may reflect estimated fare values for this future time period. The estimated fare values may be categorized by specific travel service providers (e.g., specific airlines), geographic regions (e.g., east coast, cities, etc.), length of travel (e.g., cross country flights, intrastate flights, etc.), and any other category that analysis engine 118 may be configured to implement.

At Step 340, server 110 may configure a fare history response that may include the extracted fare information stored in constant information database 160. Additionally, and if applicable, server 110 may also configure the estimated future fares determined by analysis engine 118 into the fare history response.

Server 110 may then provide the response to client 120 where a browser executed by CPU 122 may present the fare history response in a user friendly format. For example, the response may be formatted using graphical representations, along with textual data, to present the fare history information. Also, the formatted response may be configured to present past fare information based on individual travel service providers (e.g., airlines), geographic regions (e.g., east coast, west coast, states, cities, etc.), and length of travel (e.g., cross-country flights, intrastate flights, etc.). Further, the response generated by server 110 may be formatted to be compatible with different mediums. For example, server 110 may format a response in a telephonic based format for delivery to a target entity (e.g., client 120) via a wireline and/or wireless network.

Additionally, or alternatively, the response provided by server 110 may be governed by the same parameter rules that fare trend analysis process 115 used when extracting and filtering the fare information from constant information database 150. In one aspect of the invention, server 110 may perform a relational join of fare and rule parameter information stored in a relational database (e.g., constant information database 160) to generate the fare history response. Accordingly, system 100 may allow a user operating client 120 to select an input criteria associated with a corresponding rule parameter (e.g., advance purchase, minimum stay, maximum stay, travel dates, etc.) and provide the input criteria in the request sent to server 110. Server 110 may access a relational database (e.g., constant information database 160) to collect fare information and corresponding rule parameter information based on the input criteria and formulate the fare history response.

One skilled in the art would realize that the format and configuration of the response provided to client 120 and presented to the user operating client 120 may vary without departing from the scope of the present invention. For example, system 100 may implement Web Services technologies to provide fare history and/or analysis information to client 120. Web Services are “Libraries” providing data and services to other applications over a network (e.g., the Work Wide Web) through a set of interfaces and protocols. Web Services are self-contained, self-describing, modular applications that can be published, located, and invoked across the Web. Therefore, system 100 may be configured to deploy a Web Service that is associated with provide fare history information and/or fare analysis data consistent with certain aspects of the present invention. Once deployed, other applications (and other Web Services) can discover and invoke the deployed fare trend service to obtain the corresponding fare information provided by the service.

As described, methods, systems, and articles of manufacture consistent with features of the present invention allow a travel buyer and/or seller to request and historical information associated with past fares offered by travel service providers. The historical information may be presented in a user friendly format to allow the travel buyer and/or seller to determine possible future trends in fares offered by the same travel service providers. Also, methods, systems, and articles of manufacture consistent with certain principles related to the present invention may also provide a future trend analysis result associated with a calculated estimate of future fares based on past fares offered by the travel service providers. Although the examples described above referred to airlines as the travel service providers, the features and principles consistent with the present invention may be implemented with non-airline travel suppliers, such as hotels, bus services, train servers, car rental businesses, and any other business market that includes multiple providers that may adjust their fares (e.g., cost of providing services).

Variations of the methods and systems consistent with features of the present invention previously described may be implemented without departing from the scope of the invention. For example, fare trend analysis process 115 may be configured to perform its described functions without parameters rules offered by rules engine 117. Additionally, the request for historical fares received from client 120 may be automatically generated by a software application operating within client 120. Also, methods, systems, and articles of manufacture, consistent with features of the present invention may be implemented using various components, network models, etc. and are not limited to the examples described above. Furthermore, any number of programming languages may be utilized without departing from the scope of the present invention.

Furthermore, methods, systems, and articles of manufacture consistent with certain principles related to the present invention may be configured to perform variations of the process steps shown in FIGS. 2 and 3. For example, server 110 may be configured to store in variable information database 150 updated fare information associated with travel service providers that have changed travel services (e.g., fares, destination cities, etc.) since the last time server 110 collected and extracted fare information into constant information database 160. In this configuration, server 110 may be configured to maintain the fare information in database 150 and compare it with fare information recently collected to determine what fares have changed from the last download from fare provider 140.

Additionally, although aspects of the present invention are described as being associated with data stored in memory and other storage mediums, one skilled in the art will appreciate that these aspects can also be stored on or read from other types of computer-readable media, such as secondary storage devices, like hard disks, floppy disks, or CD-ROM; a carrier wave from the Internet; or other forms of RAM or ROM. Accordingly, the invention is not limited to the above described aspects of the invention, but instead is defined by the appended claims in light of their full scope of equivalents.

What is claimed is:

1. A method for providing historical fare information, comprising:
collecting fare information associated with one or more travel service providers;
storing the collected fare information in a first database;
extracting, from the first database, a set of fare information that conforms to a predefined travel rule;
storing the set of fare information in a second database; and
making the set of fare information available to a requesting entity in response to a request for historical fare information.

2. The method of claim 1, wherein the predefined travel rule is associated with criteria that the travel service providers require to offer fares at a reduced value.

3. The method of claim 1, wherein the collecting step is performed periodically for a predetermined amount of time.

4. The method of claim 3, wherein the predetermined amount of time is one of a predetermined number of days, a predetermined number of weeks, a predetermined number of months, and a predetermined number of years.

5. The method of claim 3, wherein the collecting step is performed one of hourly, daily, weekly, monthly, and annually for the predetermined amount of time.

6. The method of claim 1, wherein the set of fare information reflects the lowest fares offered by the travel service providers among the fares stored in the first database.

7. The method of claim 1, wherein making the set of fare information available to a requesting entity includes:
employing a web service configured to provide the set of fare information.

8. A method for providing historical fare information, comprising:
periodically collecting fares associated with every flight offered from each of a plurality of airlines within a predefined market, wherein each offered flight is associated with a source and a destination city;
storing the collected fares into a variable information database;
determining, for each flight associated with the same source and destination city, a lowest fare offered among the airlines for the respective flight;
storing each of the determined lowest fares in a constant information database; and
making the determined lowest fares available to a user in response to a request for historical fare information.

9. The method of claim 8, wherein the step of periodically collecting is continuously performed for a predetermined amount of time.

10. The method of claim 8, wherein the step of periodically collecting is performed one of daily, weekly, monthly, and yearly.

11. The method of claim 9, wherein the predetermined amount of time is one of one or more days, one or more weeks, one or more months, and one or more years.

12. The method of claim 11, wherein the request is made by the user after the predetermined amount of time has been reached.

13. The method of claim 11, wherein the request is made by the user before the predetermined amount of time has been reached.

14. The method of claim 8, wherein making the determined lowest fares available to a user further comprises:
generating a response that includes the lowest fare information offered each day for each of the flights based on the lowest fares stored in the constant information database; and
making the response available to the user in response to the request.

15. The method of claim 14, wherein the response is provided in at least one of textual and graphical form.

16. The method of claim 8, wherein the determined lowest fare offered among the airlines for the respective flight is based on a parameter rule.

17. The method of claim 15, wherein the parameter rule is associated with advance purchase offers provided by one or more of the plurality of airlines.

18. The method of claim 8, wherein making the determined lowest fares available to a user includes:
employing a web service configured to provide the lowest fares to the user.

19. A method for providing historical fare information, comprising:
collecting available fares previously offered by a set of travel service providers;
collecting a set of lowest fares from among the collected available fares, wherein the collecting of available fares and a set of lowest fares are performed periodically for a predetermined amount of time;
determining an estimate of future fares that may be offered by the set of travel service providers based on the collected set of lowest fares; and
making the set of collected lowest fares and the estimate of future fares available to an entity in response to a request for historical fares.

20. A system for providing historical fare information, comprising:
a first computer for requesting historical fare information associated with a travel opportunity; and
a second computer for providing, to the first computer, a response including the historical fare information based on the request, wherein the second computer includes:
a memory including:
a first data component for periodically collecting historical fares offered by a set of travel service providers for a predetermined amount of time,
a second data component for periodically extracting the lowest fares from among the collected historical fares, and
a third data component for generating the response, wherein the response includes information reflecting the lowest fares associated with the travel opportunity previously offered by the set of travel service providers over the predetermined amount of time, and
a processor for executing the first through third data components to provide the response to the first computer.

21. The system of claim 20, wherein each travel service provider may include one of an airline, a hotel, a train server provider, a bus service, a car rental service, and a cruise line service.

22. A system for providing historical fare information, comprising:
a first computer for requesting historical fare information; and
a second computer for providing, to the first computer, a response including the historical fare information based on the request, wherein the first computer includes:
a memory including:
a first data component for periodically collecting historical fares offered by a set of travel service providers for a predetermined amount of time,
a second data component for periodically extracting the lowest fares from among the collected historical fares,
a third data component for determining estimated future fares associated with the set of travel service providers based on the extracted lowest fares, and
a fourth data component for generating the response, wherein the response includes the lowest fares previously offered by the set of travel service providers over the predetermined amount of time and the determined estimated future fares, and
a processor for executing the first through fourth data components to provide the response to the first computer.

23. A method for receiving historical fare information associated with a travel opportunity, comprising:
providing a request for historical fare information associated with a selected travel opportunity; and
receiving a response to the request including at least one of historical fare information reflecting fares previously offered by one or more travel service providers that offer a travel opportunity similar to the selected travel opportunity and new fare information reflecting an estimate of new fares for the selected travel opportunity based on the historical fare information.

24. The method of claim 23, wherein the travel opportunity is associated with at least one of travel between a selected source and destination location, travel within a predetermined geographic region, and travel having a predetermined duration.

25. The method of claim 24, wherein the providing the request includes at least one of:
selecting the source and destination locations;
selecting the predetermined geographic locations; and
selecting the predetermined duration.

26. A computer-readable medium including instructions for performing a method, when executed by a processor for providing historical fare information, the method comprising:
collecting fare information associated with one or more travel service providers;
storing the collected fare information in a first database;
extracting, from the first database, a set of fare information that conforms to a predefined travel rule;
storing the set of fare information in a second database; and
making the set of fare information available to a requesting entity in response to a request for historical fare information.

27. The computer-readable medium of claim 26, wherein the predefined travel rule is associated with criteria that the travel service providers require to offer fares at a reduced value.

28. The computer-readable medium of claim 26, wherein the collecting step is performed periodically for a predetermined amount of time.

29. The computer-readable medium of claim 28, wherein the predetermined amount of time is one of a predetermined number of days, a predetermined number of weeks, a predetermined number of months, and a predetermined number of years.

30. The computer-readable medium of claim 28 wherein the collecting step is performed one of hourly, daily, weekly, monthly, and annually for the predetermined amount of time.

31. The computer-readable medium of claim 26, wherein the set of fare information reflects the lowest fares offered by the travel service providers among the fares stored in the first database.

32. A computer-readable medium including instructions for performing a method, when executed by a processor, for providing historical fare information, the method comprising:
periodically collecting fares associated with every flight offered from each of a plurality of airlines within a predefined market, wherein each offered flight is associated with a source and a destination city;
storing the collected fares into a variable information database;
determining, for each flight associated with the same source and destination city, the lowest fare offered among the airlines for the respective flight;
storing each of the determined lowest fares in a constant information database; and
making the determined lowest fares available to a user in response to a request for historical fare information.

33. The computer-readable medium of claim 32, wherein the step of periodically collecting is continuously performed for a predetermined amount of time.

34. The computer-readable medium of claim 32, wherein the step of periodically collecting is performed one of daily, weekly, monthly, and yearly.

35. The computer-readable medium of claim 33, wherein the predetermined amount of time is one of one or more days, one or more weeks, one or more months, and one or more years.

36. The computer-readable medium of claim 33, wherein the request is made by the user after the predetermined amount of time has been reached.

37. The computer-readable medium of claim 33, wherein the request is made by the user before the predetermined amount of time has been reached.

38. The computer-readable medium of claim 32, wherein making the determined lowest fares available to a user further comprises:
generating a response that includes the lowest fare information offered each day for each of the flights based on the lowest fares stored in the constant information database; and
making the response available to the user in response to the request.

39. The computer-readable medium of claim 38, wherein the response is provided in at least one of textual and graphical form.

40. The computer-readable medium of claim 32, wherein the determined lowest fare offered among the airlines for the respective flight is based on a parameter rule.

41. The computer-readable medium of claim 40, wherein the parameter rule is associated with advance purchase offers provided by one or more of the plurality of airlines.

42. A computer-readable medium including instructions for performing a method, when executed by a processor, for providing historical fare information, the method comprising:
collecting available fares previously offered by a set of travel service providers;
collecting a set of lowest fares from among the collected available fares, wherein the collecting of available fares and a set of lowest fares are performed periodically for a predetermined amount of time;
determining an estimate of future fares that may be offered by the set of travel service providers based on the collected set of lowest fares; and
making the set of collected lowest fares and the estimate of future fares available to an entity in response to a request for historical fares.
